(19) United States
(12) Patent Application Publication
(10) Pub. No.: US 2024/0104458 A1
(43) Pub. Date: Mar. 28, 2024

(54) MACHINE LEARNING BASED RESOURCE ALLOCATION OPTIMIZATION

(71) Applicant: Maplebear Inc. (dba Instacart), San Francisco, CA (US)

(72) Inventors: Wa Yuan, Alameda, CA (US); Jae Cho, Bellevue, WA (US); Yijia Chen, Oakland, CA (US); Houtao Deng, Sunnyvale, CA (US); Soren Zeliger, Oakland, CA (US); Aman Jain, Toronto (CA); Jian Wang, Saratoga, CA (US); Ji Chen, Mountain View, CA (US)

(21) Appl. No.: 17/955,407

(22) Filed: Sep. 28, 2022

(51) Int. Cl. G06Q 10/06; G06N 5/02; G06Q 30/06

(52) U.S. Cl. CPC G06Q 10/063116; G06N 5/022; G06Q 10/06393; G06Q 30/0637

(57) ABSTRACT

An online concierge system determines a quantity of a resource available in a timeslot to fulfill orders during the timeslot. The orders include immediate orders placed during the timeslot and scheduled orders that are scheduled for fulfillment during the timeslot. The online concierge system applies the quantity of the resource to a machine learning model to produce a predicted relationship between a value of a fulfillment metric and an allocation of the quantity of the resource reserved for immediate orders. The online concierge system determines, based on the predicted relationship, an expected optimal allocation of the quantity of the resource that maximizes the fulfillment metric. The online concierge system reserves the expected optimal allocation of the quantity of the resource for immediate orders.

### BACKGROUND

This disclosure relates generally to computer hardware and software for ordering an item through an online system, and more specifically to optimizing the allocation of resources using machine learning.

Users place orders using an online system. Orders can be immediate, in which case the orders are fulfilled as quickly as possible, or orders can be scheduled, in which case the orders are fulfilled at respective scheduled times. Any given timeslot has a limited supply of resources, e.g., shoppers, to fulfill orders in that timeslot. If all or most resources available in a given timeslot are already assigned to already-scheduled orders to be fulfilled during that timeslot, then there are likely not enough resources available to also fulfill immediate orders placed during that timeslot. This can decrease the ability of the system to satisfy immediate orders, such as causing delays in immediate order fulfillment. Furthermore, over reserving resources for immediate needs by rejecting scheduled orders coming in days prior could also encounter circumstance where immediate orders were less than expected, which ends up not using the reserved resources, effectively wasting these resources during that timeslot.

### SUMMARY

In accordance with one or more aspects of the disclosure, an online concierge system determines a quantity of a resource available in a timeslot to fulfill orders during the timeslot. The orders include immediate orders placed during the timeslot and scheduled orders that are scheduled for fulfillment during the timeslot. The online concierge system applies the quantity of the resource to a machine learning model to produce a predicted relationship between a value of a fulfillment metric and an allocation of the quantity of the resource reserved for immediate orders. The online concierge system determines, based on the predicted relationship, an expected optimal allocation of the quantity of the resource that maximizes the fulfillment metric. The online concierge system reserves the expected optimal allocation of the quantity of the resource for immediate orders. In this manner, the online concierge system can optimize resource allocation, in terms of the fulfillment metric, by selecting the allocation of resources that is expected to maximize the fulfillment metric for that timeslot. As used herein, “optimal” does not necessarily refer to a mathematically optimal solution, but can also refer to a near-optimal solution as approximated, for example, by a machine learning model.

In one or more embodiments, the online concierge system receives a potential scheduled order for fulfillment during the timeslot and checks whether a portion of the quantity of the resource, besides the reserved expected optimal allocation of the quantity of the resource, is available to fulfill the potential scheduled order. In one or more embodiments, the online concierge system determines that there is not the portion of the quantity of the resource available to fulfill the potential scheduled order and declines the potential scheduled order. In one or more embodiments, the online concierge system determines that there is the portion of the quantity of the resource available to fulfill the potential scheduled order, and confirms the potential scheduled order.

In one or more embodiments, the machine learning model is trained on experimentally gathered data. The experimentally gathered data includes a plurality of experimental timeslots and, for each experimental timeslot in the plurality of experimental timeslots, one or more of: a quantity of the resource available during the experimental timeslot, a quantity of immediate orders during the experimental timeslot, a quantity of scheduled orders during the experimental timeslot, an experimental allocation of the quantity of the resource reserved for immediate orders during the experimental timeslot, and a resulting value of the fulfillment metric for the experimental timeslot.

In one or more embodiments, the online concierge system determines the quantity of the resource available in the timeslot to fulfill orders during the timeslot by applying a second machine learning model to the timeslot to produce an estimate of the quantity of the resource available in the timeslot to fulfill orders during the timeslot.

### BRIEF DESCRIPTION OF THE DRAWINGS

FIG. 1 is a block diagram of a system environment in which an online system, such an online concierge system, operates, according to one or more embodiments.

FIG. 2 illustrates an environment of an online shopping concierge service, according to one or more embodiments.

FIG. 3 is a diagram of an online shopping concierge system, according to one or more embodiments.

FIG. 4A is a diagram of a customer mobile application (CMA), according to one or more embodiments.

FIG. 4B is a diagram of a shopper mobile application (SMA), according to one or more embodiments.

FIG. 5A illustrates a visualization of resource allocation over time, according to one or more embodiments.

FIG. 5B illustrates a visualization of resource allocation optimization, according to one or more embodiments.

FIG. 6 is a flowchart illustrating a process of an online concierge system, according to one or more embodiments.

The figures depict embodiments of the present disclosure for purposes of illustration only. Alternative embodiments of the structures and methods illustrated herein may be employed without departing from the principles, or benefits touted, of the disclosure described herein.

### DETAILED DESCRIPTION

### System Architecture

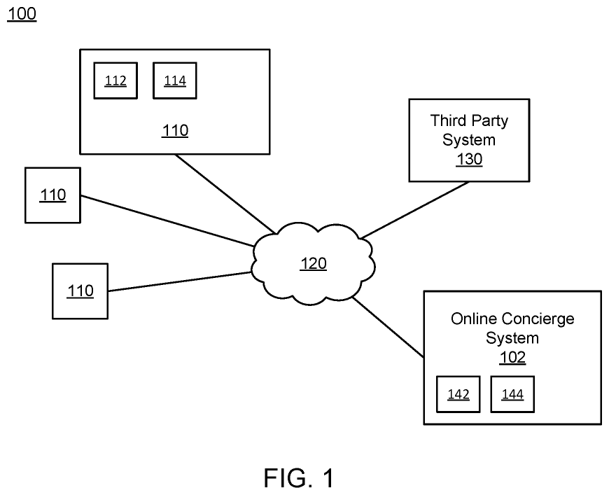

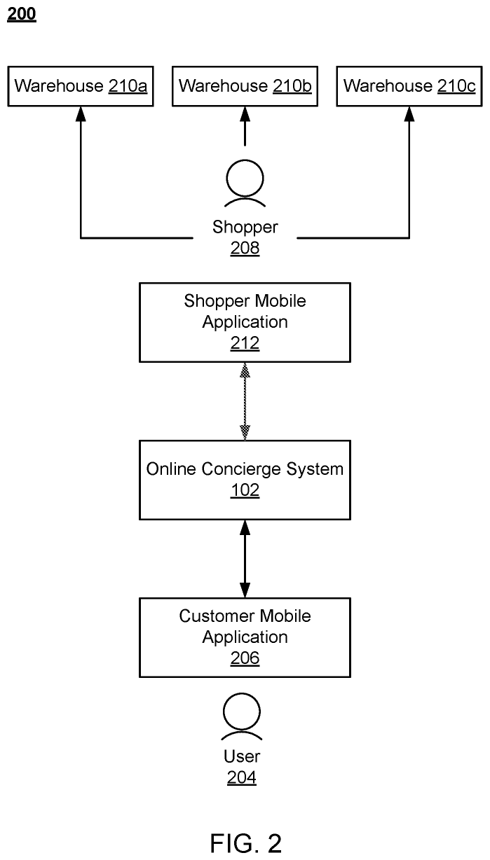

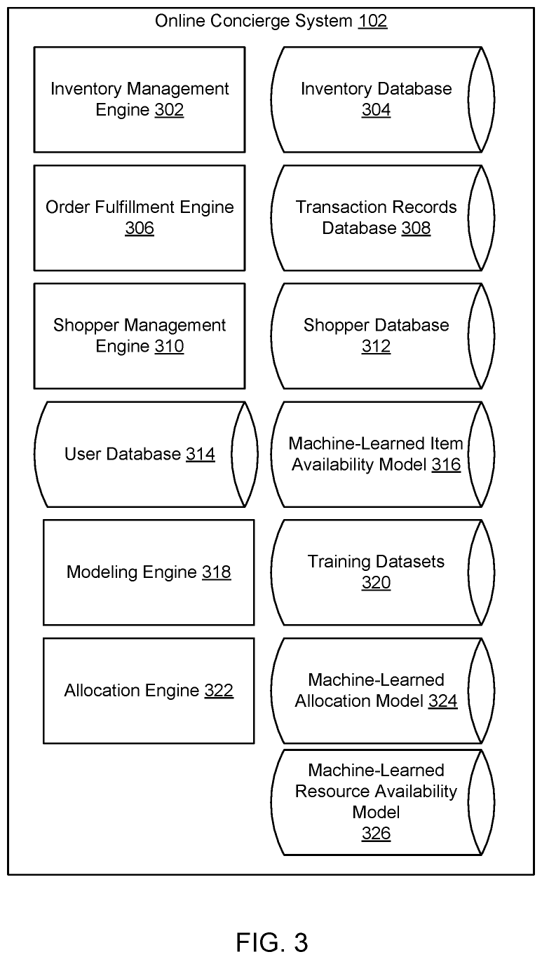

FIG. 1 is a block diagram of a system environment 100 in which an online system, such as an online concierge system 102 as further described below in conjunction with FIGS. 2 and 3, operates. The system environment 100 shown by FIG. 1 comprises one or more client devices 110, a network 120, one or more third-party systems 130, and the online concierge system 102. In alternative configurations, different and/or additional components may be included in the system environment 100. Additionally, in other embodiments, the online concierge system 102 may be replaced by an online system configured to retrieve content for display to users and to transmit the content to one or more client devices 110 for display.

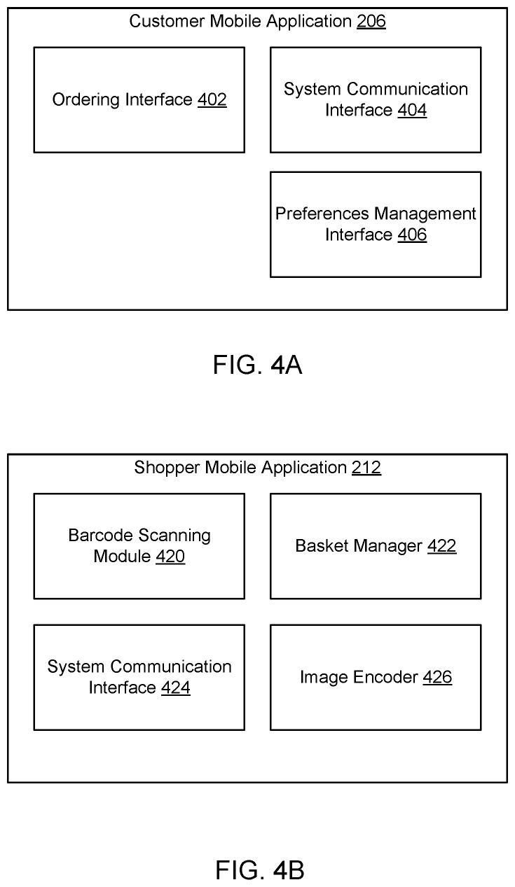

The client devices 110 are one or more computing devices capable of receiving user input as well as transmitting and/or receiving data via the network 120. In one embodiment, a client device 110 is a computer system, such as a desktop or a laptop computer. Alternatively, a client device 110 may be a device having computer functionality, such as a personal digital assistant (PDA), a mobile telephone, a smartphone, or another suitable device. A client device 110 is configured to communicate via the network 120. In one embodiment, a client device 110 executes an application allowing a user of the client device 110 to interact with the online concierge system 102. For example, the client device 110 executes a customer mobile application 206 or a shopper mobile application 212, as further described below in conjunction with FIGS. 4A and 4B, respectively, to enable interaction between the client device 110 and the online concierge system 102. As another example, a client device 110 executes a browser application to enable interaction between the client device 110 and the online concierge system 102 via the network 120. In another embodiment, a client device 110 interacts with the online concierge system 102 through an application programming interface (API) running on a native operating system of the client device 110, such as IOS® or ANDROID™.

A client device 110 includes one or more processors 112 configured to control operation of the client device 110 by performing functions. In various embodiments, a client device 110 includes a memory 114 comprising a non-transitory storage medium on which instructions are encoded. The memory 114 may have instructions encoded thereon that, when executed by the processor 112, cause the processor to perform functions to execute the customer mobile application 206 or the shopper mobile application 212 to provide the functions further described above in conjunction with FIGS. 4A and 4B, respectively.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online concierge system 102 or with the one or more client devices 110. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. For example, the third party system 130 stores one or more web pages and transmits the web pages to a client device 110 or to the online concierge system 102. The third party system 130 may also communicate information to the online concierge system 102, such as advertisements, content, or information about an application provided by the third party system 130. In one or more embodiments, the third party system 130 is a computing system of a warehouse that sends catalog and/or inventory information to the online concierge system 102.

The online concierge system 102 includes one or more processors 142 configured to control operation of the online concierge system 102 by performing functions. In various embodiments, the online concierge system 102 includes a memory 144 comprising a non-transitory storage medium on which instructions are encoded. The memory 144 may have instructions encoded thereon corresponding to the modules further below in conjunction with FIG. 3 that, when executed by the processor 142, cause the processor to perform the functionality further described herein. For example, the memory 144 has instructions encoded thereon that, when executed by the processor 142, cause the processor 142 to generate instructions for the online concierge system 102 to allocate a particular quantity of a resource in a particular timeslot to a particular type of order. Additionally, the online concierge system 102 includes a communication interface configured to connect the online concierge system 102 to one or more networks, such as network 120, or to otherwise communicate with devices (e.g., client devices 110) connected to the one or more networks.

One or more of a client device, a third party system 130, or the online concierge system 102 may be special purpose computing devices configured to perform specific functions, as further described below in conjunction with FIGS. 2-6, and may include specific computing components such as processors, memories, communication interfaces, and/or the like.

### System Overview

FIG. 2 illustrates an environment 200 of an online platform, such as an online concierge system 102, according to one embodiment. The figures use like reference numerals to identify like elements. A letter after a reference numeral, such as “210a,” indicates that the text refers specifically to the element having that particular reference numeral. A reference numeral in the text without a following letter, such as “210,” refers to any or all of the elements in the figures bearing that reference numeral. For example, “210” in the text refers to reference numerals “210a” or “210b” in the figures.

The environment 200 includes an online concierge system 102. The online concierge system 102 is configured to receive orders from one or more users 204 (only one is shown for the sake of simplicity). An order specifies a list of goods (i.e., items, products) to be delivered to the user 204. The order also specifies the location to which the goods are to be delivered, and a time window during which the goods should be delivered. In some embodiments, the order specifies one or more retailers from which the selected items should be purchased. The user may use a customer mobile application (CMA) 206 to place the order; the CMA 206 is configured to communicate with the online concierge system 102.

The online concierge system 102 is configured to transmit orders received from users 204 to one or more shoppers 208. A shopper 208 may be a contractor, employee, other person (or entity), robot, or other autonomous device enabled to fulfill orders received by the online concierge system 102. The shopper 208 travels between a warehouse and a delivery location (e.g., the user's home or office). A shopper 208 may travel by car, truck, bicycle, scooter, foot, or other mode of transportation. In some embodiments, the delivery may be partially or fully automated, e.g., using a self-driving car. The environment 200 also includes three warehouses 210a, 210b, and 210c (only three are shown for the sake of simplicity; the environment could include hundreds of warehouses). The warehouses 210 may be physical retailers, such as grocery stores, discount stores, department stores, etc., or non-public warehouses storing items that can be collected and delivered to users. Each shopper 208 fulfills an order received from the online concierge system 102 at one or more warehouses 210, delivers the order to the user 204, or performs both fulfillment and delivery. In one embodiment, shoppers 208 make use of a shopper mobile application 212 which is configured to interact with the online concierge system 102.

FIG. 3 is a diagram of an online concierge system 102, according to one or more embodiments. In various embodiments, the online concierge system 102 may include different or additional modules than those described in conjunction with FIG. 3. Further, in some embodiments, the online concierge system 102 includes fewer modules than those described in conjunction with FIG. 3.

The online concierge system 102 includes an inventory management engine 302, which interacts with inventory systems associated with each warehouse 210. In one embodiment, the inventory management engine 302 requests and receives inventory information maintained by the warehouse 210. The inventory of each warehouse 210 is unique and may change over time. The inventory management engine 302 monitors changes in inventory for each participating warehouse 210. The inventory management engine 302 is also configured to store inventory records in an inventory database 304. The inventory database 304 may store information in separate records—one for each participating warehouse 210—or may consolidate or combine inventory information into a unified record. Inventory information includes attributes of items that include both qualitative and qualitative information about items, including size, color, weight, SKU, serial number, and so on. In one embodiment, the inventory database 304 also stores purchasing rules associated with each item if they exist. For example, age-restricted items such as alcohol and tobacco are flagged accordingly in the inventory database 304. Additional inventory information useful for predicting the availability of items may also be stored in the inventory database 304. For example, for each item-warehouse combination (a particular item at a particular warehouse), the inventory database 304 may store a time that the item was last found, a time that the item was last not found (a shopper looked for the item but could not find it), the rate at which the item is found, and the popularity of the item.

For each item, the inventory database 304 identifies one or more attributes of the item and corresponding values for each attribute of an item. For example, the inventory database 304 includes an entry for each item offered by a warehouse 210, with an entry for an item including an item identifier that uniquely identifies the item. The entry includes different fields, with each field corresponding to an attribute of the item. A field of an entry includes a value for the attribute corresponding to the attribute for the field, allowing the inventory database 304 to maintain values of different categories for various items.

In various embodiments, the inventory management engine 302 maintains a taxonomy of items offered for purchase by one or more warehouses 210. For example, the inventory management engine 302 receives an item catalog from a warehouse 210 identifying items offered for purchase by the warehouse 210. From the item catalog, the online concierge system 102 determines a taxonomy of items offered by the warehouse 210. Different levels in the taxonomy provide different levels of specificity about items included in the levels. In various embodiments, the taxonomy identifies a category and associates one or more specific items with the category. For example, a category identifies “milk,” and the taxonomy associates identifiers of different milk items (e.g., milk offered by different brands, milk having one or more different attributes, etc.), with the category. Each category has a category label, such as a “milk” category label for the respective “milk” category. Thus, the taxonomy maintains associations between a category and specific items offered by the warehouse 210 matching the category.

In various embodiments, the taxonomy identifies a generic item description corresponding to a category and associates one or more specific items with the category based on their similarity to the generic item description. For example, a generic item description identifies “milk,” and the taxonomy associates identifiers of different milk items (e.g., milk offered by different brands, milk having one or more different attributes, etc.), with the category. Thus, the taxonomy maintains associations between a generic item description and specific items offered by the warehouse matching the generic item description.

In some embodiments, different levels in the taxonomy identify items with differing levels of specificity based on any suitable attribute or combination of attributes of the items. For example, different levels of the taxonomy specify different combinations of attributes for items, so items in lower levels of the hierarchical taxonomy have a greater number of attributes, corresponding to greater specificity in a category, while items in higher levels of the hierarchical taxonomy have a fewer number of attributes, corresponding to less specificity in a category. In various embodiments, higher levels in the taxonomy include less detail about items, so greater numbers of items are included in higher levels (e.g., higher levels include a greater number of items satisfying a broader category). Similarly, lower levels in the taxonomy include greater detail about items, so fewer numbers of items are included in the lower levels (e.g., lower levels include a fewer number of items satisfying a more specific category).

For example, each category label corresponds to a taxonomy node in the hierarchical item taxonomy, which may be a hierarchical taxonomy tree or hierarchical taxonomy graph that includes edges and nodes. Each level of the hierarchical item taxonomy includes one or more taxonomy nodes corresponding to respective category of a particular level of specificity. Each taxonomy node has as children zero or more child taxonomy nodes at a lower level. A taxonomy node's child taxonomy nodes correspond to categories that divide the items matching the generic item description of the taxonomy node according to more specific generic item identifiers. For example, a taxonomy node for “vegetables” may have as child taxonomy nodes “broccoli,” “carrots,” “cauliflower,” and “brussels sprouts.” The “carrots” taxonomy node may have as children “whole carrot,” “shredded carrot,” “baby carrot,” etc.

The taxonomy may be received from a warehouse 210 in various embodiments. In other embodiments, the inventory management engine 302 applies a trained classification model to an item catalog received from a warehouse 210 to include different items in levels of the taxonomy, so application of the trained classification model associates specific items with categories corresponding to levels within the taxonomy.

Inventory information provided by the inventory management engine 302 may supplement the training datasets 320. Inventory information provided by the inventory management engine 302 may not necessarily include information about the outcome of picking a delivery order associated with the item, whereas the data within the training datasets 320 is structured to include an outcome of picking a delivery order (e.g., if the item in an order was picked or not picked).

The online concierge system 102 also includes an order fulfillment engine 306 which is configured to synthesize and display an ordering interface to each user 204 (for example, via the customer mobile application 206). The order fulfillment engine 306 is also configured to access the inventory database 304 in order to determine which products are available at which warehouse 210. The order fulfillment engine 306 may supplement the product availability information from the inventory database 304 with an item availability predicted by the machine learning item availability model 316. The order fulfillment engine 306 determines a sale price for each item ordered by a user 204. Prices set by the order fulfillment engine 306 may or may not be identical to in-store prices determined by retailers (which is the price that users 204 and shoppers 208 would pay at the retail warehouses). The order fulfillment engine 306 also facilitates transactions associated with each order. In one embodiment, the order fulfillment engine 306 charges a payment instrument associated with a user 204 when he/she places an order. The order fulfillment engine 306 may transmit payment information to an external payment gateway or payment processor. The order fulfillment engine 306 stores payment and transactional information associated with each order in a transaction records database 308.

In various embodiments, the order fulfillment engine 306 generates and transmits a search interface to a client device of a user for display via the customer mobile application. The order fulfillment engine 306 receives a query comprising one or more terms from a user and retrieves items satisfying the query, such as items having descriptive information matching at least a portion of the query. In various embodiments, the order fulfillment engine 306 leverages item embeddings for items to retrieve items based on a received query. For example, the order fulfillment engine 306 generates an embedding for a query and determines measures of similarity between the embedding for the query and item embeddings for various items included in the inventory database 304.

In some embodiments, the order fulfillment engine 306 also shares order details with warehouses 210. For example, after successful fulfillment of an order, the order fulfillment engine 306 may transmit a summary of the order to the appropriate warehouses 210. The summary may indicate the items purchased, the total value of the items, and in some cases, an identity of the shopper 208 and user 204 associated with the transaction. In one embodiment, the order fulfillment engine 306 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 306, which provides detail of all orders which have been processed since the last request.

The order fulfillment engine 306 may interact with a shopper management engine 310, which manages communication with and utilization of shoppers 208. In one embodiment, the shopper management engine 310 receives a new order from the order fulfillment engine 306. The shopper management engine 310 identifies the appropriate warehouse 210 to fulfill the order based on one or more parameters, such as a probability of item availability determined by a machine learning item availability model 316, the contents of the order, the inventory of the warehouses, and the proximity to the delivery location. The shopper management engine 310 then identifies one or more appropriate shoppers 208 to fulfill the order based on one or more parameters, such as the shoppers' proximity to the appropriate warehouse 210 (and/or to the user 204), his/her familiarity level with that particular warehouse 210, and so on. Additionally, the shopper management engine 310 accesses a shopper database 312 which stores information describing each shopper 208, such as his/her name, gender, rating, previous shopping history, and so on.

As part of fulfilling an order, the order fulfillment engine 306 and/or shopper management engine 310 may access a user database 314 which stores information describing each user. This information could include each user's name, address, gender, shopping preferences, favorite items, stored payment instruments, and so on.

The user database 314 may store one or more user profiles. A client device 110 with a customer mobile application 206 may be associated with a user profile. For example, if the customer mobile application 206 is associated with the user profile, the client device 110 containing the customer mobile application 206 is associated with the user profile. A customer mobile application 206 may be associated with the user profile, for example, if a user signs into the customer mobile application 206 using login information of the user profile.

The user profile may include a user embedding that characterizes the user profile, e.g., which characterizes past orders and/or other actions of the user. The online concierge system 102 may generate the user embedding based on some or all information stored in association with the user.

In various embodiments, the order fulfillment engine 306 determines whether to delay display of a received order to shoppers for fulfillment by a time interval. In response to determining to delay the received order by a time interval, the order fulfillment engine 306 evaluates orders received after the received order and during the time interval for inclusion in one or more batches that also include the received order. After the time interval, the order fulfillment engine 306 displays the order to one or more shoppers via the shopper mobile application 212; if the order fulfillment engine 306 generated one or more batches including the received order and one or more orders received after the received order and during the time interval, the one or more batches are also displayed to one or more shoppers via the shopper mobile application 212.

### Machine Learning Models

The online concierge system 102 further includes a machine learning item availability model 316, a modeling engine 318, and training datasets 320, as well as a machine learning allocation model 324 and a machine learning resource availability model 326. The modeling engine 318 uses the training datasets 320 to generate the machine learning item availability model 316, machine learning allocation model 324, and/or machine learning resource availability model 326. Depending upon the embodiment, the machine learning allocation model 324 and the machine learning resource availability model 326 may each include one or more machine learning models, e.g., to perform different functions, though for clarity of description the one or more machine learning allocation models 324 and one or more machine learning resource availability models 326 are typically described herein as one model each. For example, the machine learning allocation model 324 may include a different machine learning model for each of a set of timeslots, such as one-hour windows throughout a day. The machine learning models 316, 324, 326 can learn from the training datasets 320, rather than follow only explicitly programmed instructions.

The inventory management engine 302, order fulfillment engine 306, and/or shopper management engine 310 can use the machine learning item availability model 316 to determine a probability that an item is available at a warehouse 210. The machine learning item availability model 316 may be used to predict item availability for items being displayed to or selected by a user or included in received delivery orders. A single machine learning item availability model 316 is used to predict the availability of any number of items.

The machine learning item availability model 316 can be configured to receive as inputs information about an item, the warehouse for picking the item, and the time for picking the item. The machine learning item availability model 316 may be adapted to receive any information that the modeling engine 318 identifies as indicators of item availability. At minimum, the machine learning item availability model 316 receives information about an item-warehouse pair, such as an item in a delivery order and a warehouse at which the order could be fulfilled. Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to the item availability model 316.

The machine learning item availability model 316 contains a set of functions generated by the modeling engine 318 from the training datasets 320 that relate the item, warehouse, and timing information, and/or any other relevant inputs, to the probability that the item is available at a warehouse. Thus, for a given item-warehouse pair, the machine learning item availability model 316 outputs a probability that the item is available at the warehouse. The machine learning item availability model 316 constructs the relationship between the input item-warehouse pair, timing, and/or any other inputs and the availability probability (also referred to as “availability”) that is generic enough to apply to any number of different item-warehouse pairs. In some embodiments, the probability output by the machine learning item availability model 316 includes a confidence score. The confidence score may be the error or uncertainty score of the output availability probability and may be calculated using any standard statistical error measurement. In some examples, the confidence score is based in part on whether the item-warehouse pair availability prediction was accurate for previous delivery orders (e.g., if the item was predicted to be available at the warehouse and not found by the shopper or predicted to be unavailable but found by the shopper). In some examples, the confidence score is based in part on the age of the data for the item, e.g., if availability information has been received within the past hour, or the past day. The set of functions of the item availability model 316 may be updated and adapted following retraining with new training datasets 320. The machine learning item availability model 316 may be any machine learning model, such as a neural network, boosted tree, gradient boosted tree or random forest model. In some examples, the machine learning item availability model 316 is generated from XGBoost algorithm.

The item probability generated by the machine learning item availability model 316 may be used to determine instructions delivered to the user 204 and/or shopper 208.

The training datasets 320 relate a variety of different factors to known item availabilities from the outcomes of previous delivery orders (e.g., if an item was previously found or previously unavailable). The training datasets 320 include the items included in previous delivery orders, whether the items in the previous delivery orders were picked, warehouses associated with the previous delivery orders, and a variety of characteristics associated with each of the items (which may be obtained from the inventory database 304).

Each piece of data in the training datasets 320 includes the outcome of a previous delivery order (e.g., if the item was picked or not). The item characteristics may be determined by the machine learning item availability model 316 to be statistically significant factors predictive of the item's availability. For different items, the item characteristics that are predictors of availability may be different. For example, an item type factor might be the best predictor of availability for dairy items, whereas a time of day may be the best predictive factor of availability for vegetables. For each item, the machine learning item availability model 316 may weight these factors differently, where the weights are a result of a “learning” or training process on the training datasets 320. The training datasets 320 are very large datasets taken across a wide cross section of warehouses, shoppers, items, warehouses, delivery orders, times, and item characteristics. The training datasets 320 are large enough to provide a mapping from an item in an order to a probability that the item is available at a warehouse. In addition to previous delivery orders, the training datasets 320 may be supplemented by inventory information provided by the inventory management engine 302. In some examples, the training datasets 320 are historic delivery order information used to train the machine learning item availability model 316, whereas the inventory information stored in the inventory database 304 include factors input into the machine learning item availability model 316 to determine an item availability for an item in a newly received delivery order. In some examples, the modeling engine 318 may evaluate the training datasets 320 to compare a single item's availability across multiple warehouses to determine if an item is chronically unavailable. This may indicate that an item is no longer manufactured. The modeling engine 318 may query a warehouse 210 through the inventory management engine 302 for updated item information on these identified items.

The allocation engine 322 can use the machine learning allocation model 324 and, in some embodiments, the machine learning resource availability model 326, to determine a quantity of a resource, such as shoppers, to reserve for immediate orders in a timeslot. One machine learning allocation model 324 may be used to determine the allocation of a resource for any number of timeslots, in one or more embodiments. In one or more embodiments, the allocation engine 322 does not use the machine learning resource availability model 326, and may instead receive as input a quantity of a resource (e.g., a number of shoppers scheduled to operate during a particular timeslot). In such embodiments, the online concierge system 102 may not include a machine learning resource availability model 326.

The machine learning allocation model 324 can be configured to receive as input a quantity of a resource available in a timeslot to fulfill orders during the timeslot. The machine learning allocation model 324 may be adapted to receive any information that the modeling engine 318 identifies as indicators of allocation optimization. At minimum, the machine learning allocation model 324 receives information about a resource for a particular timeslot.

Items stored in the inventory database 304 may be identified by item identifiers. As described above, various characteristics, some of which are specific to the warehouse (e.g., a time that the item was last found in the warehouse, a time that the item was last not found in the warehouse, the rate at which the item is found, the popularity of the item) may be stored for each item in the inventory database 304. Similarly, each warehouse may be identified by a warehouse identifier and stored in a warehouse database along with information about the warehouse. A particular item at a particular warehouse may be identified using an item identifier and a warehouse identifier. In other embodiments, the item identifier refers to a particular item at a particular warehouse, so that the same item at two different warehouses is associated with two different identifiers. For convenience, both of these options to identify an item at a warehouse are referred to herein as an “item-warehouse pair.” Based on the identifier(s), the online concierge system 102 can extract information about the item and/or warehouse from the inventory database 304 and/or warehouse database and provide this extracted information as inputs to one or more machine learning models.

The machine learning allocation model 324 contains a set of functions generated by the modeling engine 318 from the training datasets 320 that relate a quantity of a resource (which may be output from the machine learning resource availability model 326) to a relationship between a value of a fulfillment metric and an allocation of the quantity of the resource reserved for immediate order. Thus, for a given timeslot, the machine learning allocation model 324 outputs a relationship between a value of a fulfillment metric and an allocation of the quantity of the resource reserved for immediate order for the timeslot.

The machine learning allocation model 324 constructs the relationships among the inputs and the output allocation. The relationships are generic enough to apply to any number of different timeslots and/or resources. The machine learning allocation model 324 may be any machine learning model, such as a neural network, boosted tree, gradient boosted tree or random forest model. In some examples, the machine learning allocation model 324 is generated from XGBoost algorithm.

The allocation generated by the machine learning allocation model 324 may be used to determine instructions delivered to one or more shoppers 208 (e.g., a client device 110 with a shopper mobile application 212) and/or the online concierge system 102 itself, as described in further detail below.

The machine learning resource availability model 326 predicts a quantity of a resource that will be available during a timeslot. For example, the machine learning resource availability model 326 predicts a number of shoppers 208 available to fulfill orders during a timeslot, e.g., from 5:00 PM to 6:00 PM. The machine learning resource availability model 326 may be trained on various data, as described in further detail below. Depending upon the embodiment, the online concierge system 102 may not include the machine learning resource availability model 326, in which embodiments the online concierge system 102 instead determines the quantity of a resource for a timeslot by other techniques. For example, in embodiments where the resource is shoppers, the quantity of the resource may be determined by the online concierge system 102 based on a number of shoppers scheduled to fulfill orders during the timeslot. Embodiments of a machine learning model for predicting a number of shoppers available to fulfill orders during a timeslot are described, for example, in U.S. application Ser. No. 17/731,810, filed Apr. 28, 2022, which is incorporated by reference herein in its entirety.

### Machine Learning Factors

The training datasets 320 include a time associated with previous delivery orders. In some embodiments, the training datasets 320 include a time of day at which each previous delivery order was placed. Time of day may impact item availability, since during high-volume shopping times, items may become unavailable that are otherwise regularly stocked by warehouses. In addition, availability may be affected by restocking schedules, e.g., if a warehouse mainly restocks at night, item availability at the warehouse will tend to decrease over the course of the day. Additionally, or alternatively, the training datasets 320 include a day of the week previous delivery orders were placed. The day of the week may impact item availability since popular shopping days may have reduced inventory of items or restocking shipments may be received on particular days. In some embodiments, training datasets 320 include a time interval since an item was previously picked in a previous delivery order. If an item has recently been picked at a warehouse, this may increase the probability that it is still available. If there has been a long time interval since an item has been picked, this may indicate that the probability that it is available for subsequent orders is low or uncertain. In some embodiments, training datasets 320 include a time interval since an item was not found in a previous delivery order. If there has been a short time interval since an item was not found, this may indicate that there is a low probability that the item is available in subsequent delivery orders. And conversely, if there has been a long time interval since an item was not found, this may indicate that the item may have been restocked and is available for subsequent delivery orders. In some examples, training datasets 320 may also include a rate at which an item is typically found by a shopper at a warehouse, a number of days since inventory information about the item was last received from the inventory management engine 302, a number of times an item was not found in a previous week, or any number of additional rate or time information. The relationships between this time information and item availability are determined by the modeling engine 318 training a machine learning model with the training datasets 320, producing the machine learning item availability model 316.

The training datasets 320 include item characteristics. In some examples, the item characteristics include a department associated with the item. For example, if the item is yogurt, it is associated with the dairy department. The department may be the bakery, beverage, nonfood, and pharmacy, produce and floral, deli, prepared foods, meat, seafood, dairy, the meat department, or dairy department, or any other categorization of items used by the warehouse. The department associated with an item may affect item availability, since different departments have different item turnover rates and inventory levels. In some examples, the item characteristics include an aisle of the warehouse associated with the item. The aisle of the warehouse may affect item availability since different aisles of a warehouse may be more frequently re-stocked than others. Additionally, or alternatively, the item characteristics include an item popularity score. The item popularity score for an item may be proportional to the number of delivery orders received that include the item. An alternative or additional item popularity score may be provided by a retailer through the inventory management engine 302. In some examples, the item characteristics include a product type associated with the item. For example, if the item is a particular brand of a product, then the product type will be a generic description of the product type, such as “milk” or “eggs.” The product type may affect the item availability, since certain product types may have a higher turnover and re-stocking rate than others or may have larger inventories in the warehouses. In some examples, the item characteristics may include a number of times a shopper was instructed to keep looking for the item after he or she was initially unable to find the item, a total number of delivery orders received for the item, whether or not the product is organic, vegan, gluten free, or any other characteristics associated with an item. The relationships between item characteristics and item availability are determined by the modeling engine 318 training a machine learning model with the training datasets 320, producing the machine learning item availability model 316.

The training datasets 320 may include additional item characteristics that affect the item availability and can therefore be used to build the machine learning item availability model 316 relating the delivery order for an item to its predicted availability. The training datasets 320 may be periodically updated with recent previous delivery orders. The training datasets 320 may be updated with item availability information provided directly from shoppers 208. Following updating of the training datasets 320, a modeling engine 318 may retrain a model with the updated training datasets 320 and produce a new machine learning item availability model 316.

The training datasets 320 may include pairs of search queries and items and/or categories labeled as relevant or non-relevant. The labeling may be manual for some or all pairs, or may be automatically determined according to user feedback. For example, training data may be generated based on user interactions with search results displayed in response to a search query, where search results interacted with by the user, as well as respective categories, are labeled as relevant and other search results and categories are labeled as non-relevant.

The training datasets 320 additionally include data to train the machine learning allocation model 324. This data can be experimental data gathered during experiments conducted using the online concierge system 102. The experimentally gathered data can include a plurality of experimental timeslots and, for each experimental timeslot in the plurality of experimental timeslots, one or more of: a quantity of the resource available during the experimental timeslot, a quantity of immediate orders during the experimental timeslot, a quantity of scheduled orders during the experimental timeslot, an experimental allocation of the quantity of the resource reserved for immediate orders during the experimental timeslot, and a resulting value of the fulfillment metric for the experimental timeslot. This data may also be used to train the machine learning resource availability model 326, depending upon the embodiment.

Customer Mobile Application

FIG. 4A is a diagram of the customer mobile application (CMA) 206, according to one embodiment. The CMA 206 includes an ordering interface 402, which provides an interactive interface with which the user can browse through and select products and place an order. The CMA 206 also includes a system communication interface 404 which, among other functions, receives inventory information from the online shopping concierge system 102 and transmits order information to the online concierge system 102. The CMA 206 also includes a preferences management interface 406 which allows the user to manage basic information associated with his/her account, such as his/her home address and payment instruments. The preferences management interface 406 may also allow the user to manage other details such as his/her favorite or preferred warehouses 210, preferred delivery times, special instructions for delivery, and so on.

### Shopper Mobile Application

FIG. 4B is a diagram of the shopper mobile application (SMA) 212, according to one embodiment. The SMA 212 includes a barcode scanning module 420 which allows a shopper 208 to scan an item at a warehouse 210 (such as a can of soup on the shelf at a grocery store). The barcode scanning module 420 may also include an interface which allows the shopper to manually enter information describing an item (such as its serial number, SKU, quantity and/or weight) if a barcode is not available to be scanned. SMA 212 also includes a basket manager 422 which maintains a running record of items collected by the shopper 208 for purchase at a warehouse 210. This running record of items is commonly known as a “basket.” In one embodiment, the barcode scanning module 420 transmits information describing each item (such as its cost, quantity, weight, etc.) to the basket manager 422, which updates its basket accordingly. The SMA 212 also includes a system communication interface 424 which interacts with the online shopping concierge system 102. For example, the system communication interface 424 receives an order from the online concierge system 102 and transmits the contents of a basket of items to the online concierge system 102. The SMA 212 also includes an image encoder 426 which encodes the contents of a basket into an image. For example, the image encoder 426 may encode a basket of goods (with an identification of each item) into a QR code which can then be scanned by an employee of the warehouse 210 at check-out.

### Allocation Engine

Turning back to FIG. 3, the allocation engine 322 evaluates data related to a timeslot to determine what fraction of a quantity of a resource available during that timeslot to reserve (i.e., allocate) exclusively to immediate orders placed during the timeslot. The allocation engine 322 applies the machine learning allocation model 324 to timeslot data, such as the quantity of a resource available during the timeslot, to produce a relationship between the value of a fulfillment metric and the amount of the resource reserved for immediate orders. The fulfillment metric can vary depending upon the embodiment, and can include a conversion rate, as defined below, and/or a quantity of revenue, a number of fulfilled orders, a quality of the fulfillment, or so on. The fulfillment metric can be any metric related to the fulfillment of orders during a timeslot. Depending upon the embodiment, the resource can be shoppers, vehicles (e.g., autonomous vehicles), or any resource related to the fulfillment of orders during a timeslot. In one or more embodiments, the allocation engine 322 applies the machine learning resource availability model 326 to determine the quantity of the resource predicted to be available during a timeslot.

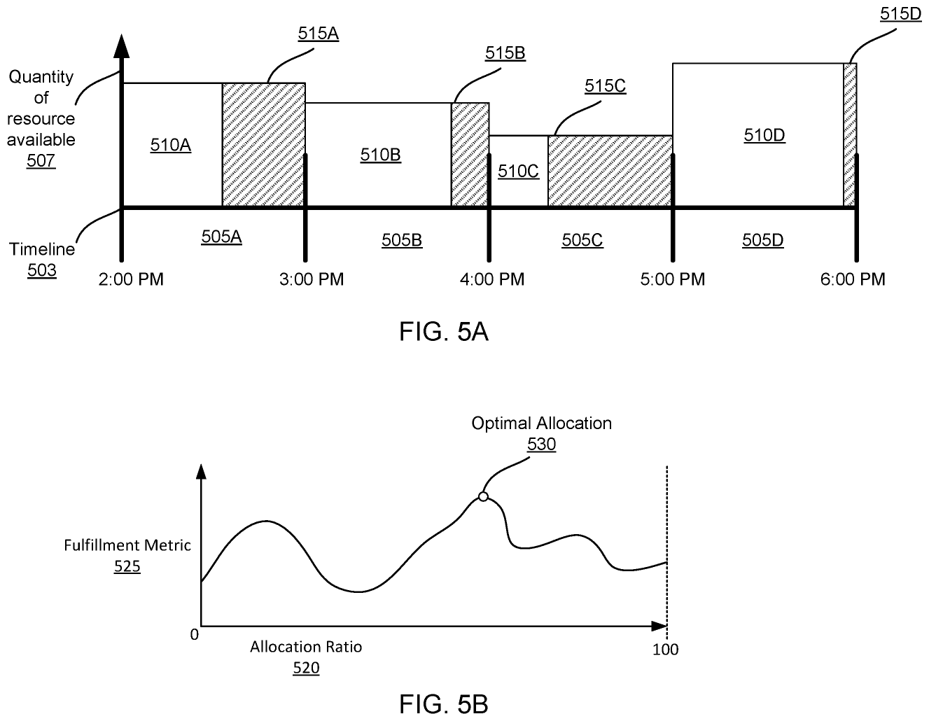

FIG. 5A illustrates a visualization of resource allocation over time, according to one or more embodiments. FIG. 5A includes a timeline 503 with various timeslots 505. Timeslot 505A is from 2:00 PM to 3:00 PM, timeslot 505B is from 3:00 PM to 4:00 PM, timeslot 505C is from 4:00 PM to 5:00 PM, and timeslot 505D is from 5:00 PM to 6:00 PM. Depending upon the embodiment, there may be any number of timeslots of any length of time. For example, in some embodiments timeslots are each one day long.

FIG. 5A also includes a visualization of the quantity of a resource available 507 during each timeslot, which is visualized as a projection perpendicular to the timeline 503. This projection, which is different for each timeslot 505 based on the quantity of the resource available 507 for each timeslot 505, combines with each timeslot 505 to form rectangles that visualize the allocation 515 of the quantity of the resource available 507 that is reserved for immediate orders during the timeslot, and the portion 510 of the quantity of the resource available 507 that is free for use for immediate orders during the timeslot or scheduled orders during the timeslot.

As illustrated in the example of FIG. 5, different timeslots 505 can have different allocations 515 (e.g., optimal allocations 515), which can depend upon the quantity of the resource available 507 during the timeslot. In the example of the figure, timeslot 505A has an allocation 515A that is roughly half the quantity of the resource available 507 for that timeslot 505D, while timeslot 505D has an allocation 515D that is a sliver of the quantity of the resource available 507 for that timeslot 505D. The optimal allocation 515 is determined using the machine learning allocation model 324 as described above, which is visualized for an example timeslot in FIG. 5B.

FIG. 5B illustrates a visualization of resource allocation optimization, according to one or more embodiments. For a particular timeslot, the online concierge system 102 uses the machine learning allocation model 324 to produce a relationship between a fulfillment metric 525 and an allocation ratio 520. The allocation ratio 520 is the allocation, the amount of the quantity of the resource that is reserved in the timeslot for immediate orders. This can range from none of the quantity of the resource (0%) to all of the quantity of the resource (100%). For each potential allocation ratio 520, the relationship produced by the machine learning allocation model 324 outputs a respective estimated value of a fulfillment metric 525. The online concierge system 102 evaluates the curve produced by the relationship over the domain of the possible allocation ratios 520 to identify a particular allocation ratio 520 to use as the allocation for the timeslot. The particular allocation ratio 520 selected by the online concierge system 102 is the particular allocation ratio 520 that maximizes the value of the fulfillment metric 525, e.g., the highest peak on the curve.

In this manner, the online concierge system 102 can optimize resource allocation, in terms of the fulfillment metric, by selecting the allocation of resources that is expected to maximize the fulfillment metric 525 for that timeslot.

### Example Methods

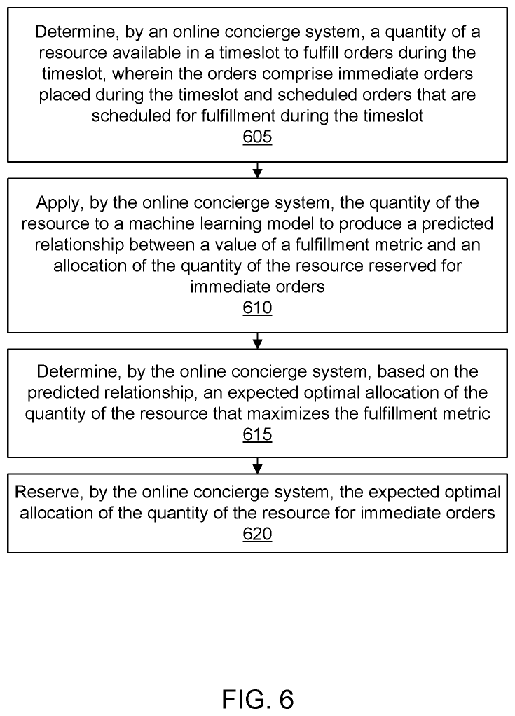

FIG. 6 is a flowchart illustrating a process of an online concierge system to optimize resource allocation, according to one or more embodiments. In various embodiments, the method includes different or additional steps than those described in conjunction with FIG. 6. Further, in some embodiments, the steps of the method may be performed in different orders than the order described in conjunction with FIG. 6. The method described in conjunction with FIG. 6 may be carried out by the online concierge system 102 in various embodiments, while in other embodiments, the steps of the method are performed by any computing system.

An online concierge system determines 605 a quantity of a resource available in a timeslot to fulfill orders during the timeslot. The orders include immediate orders placed during the timeslot and scheduled orders that are scheduled for fulfillment during the timeslot. The online concierge system applies 610 the quantity of the resource to a machine learning model to produce a predicted relationship between a value of a fulfillment metric and an allocation of the quantity of the resource reserved for immediate orders. The online concierge system determines 615, based on the predicted relationship, an expected optimal allocation of the quantity of the resource that maximizes the fulfillment metric. The online concierge system reserves 620 the expected optimal allocation of the quantity of the resource for immediate orders.

In one or more embodiments, the online concierge system receives a potential scheduled order for fulfillment during the timeslot and checks whether a portion of the quantity of the resource, besides the reserved expected optimal allocation of the quantity of the resource, is available to fulfill the potential scheduled order. In one or more embodiments, the online concierge system determines that there is not the portion of the quantity of the resource available to fulfill the potential scheduled order and declines the potential scheduled order. In one or more embodiments, the online concierge system determines that there is the portion of the quantity of the resource available to fulfill the potential scheduled order, and confirms the potential scheduled order.

In one or more embodiments, the machine learning model is trained on experimentally gathered data. The experimentally gathered data includes a plurality of experimental timeslots and, for each experimental timeslot in the plurality of experimental timeslots, one or more of: a quantity of the resource available during the experimental timeslot, a quantity of immediate orders during the experimental timeslot, a quantity of scheduled orders during the experimental timeslot, an experimental allocation of the quantity of the resource reserved for immediate orders during the experimental timeslot, and a resulting value of the fulfillment metric for the experimental timeslot.

In one or more embodiments, the online concierge system determines the quantity of the resource available in the timeslot to fulfill orders during the timeslot by applying a second machine learning model to the timeslot to produce an estimate of the quantity of the resource available in the timeslot to fulfill orders during the timeslot.

Additional Considerations

The foregoing description of the embodiments has been presented for the purpose of illustration; it is not intended to be exhaustive or to limit the embodiments to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a computing device selectively activated or reconfigured by a computer program stored in the computer. Such a computer program may be stored in a tangible computer readable storage medium, which includes any type of tangible media suitable for storing electronic instructions and coupled to a computer system bus. Furthermore, any computing systems referred to in the specification may include a single processor or may be architectures employing multiple processor designs for increased computing capability.

Embodiments may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the claims be limited not by this detailed description, but rather by any claims that issue on an application based hereon. Accordingly, the disclosure of the embodiments is intended to be illustrative, but not limiting, of the scope of the claims, which is set forth in the following.

What is claimed is:

1. A method performed by a computing system comprising a non-transitory memory and a processor, the method comprising:
receiving a plurality of orders at an online system from devices associated with a plurality of users of the online system, each order comprising a request for the online system to fulfill the order during a timeslot, wherein the plurality of orders comprise one or more immediate orders placed during the timeslot and one or more scheduled orders that are scheduled before the timeslot for fulfillment during the timeslot;
determining, by the online system, a quantity of a resource available in the timeslot to fulfill the plurality of orders during the timeslot;
applying, by the online system, the quantity of the resource to a machine learning model to produce a predicted relationship between a value of a fulfillment metric and an allocation of the quantity of the resource reserved for immediate orders;
determining, by the online system, based on the predicted relationship, an expected optimal allocation of the quantity of the resource that maximizes the fulfillment metric;
reserving, by the online system, the expected optimal allocation of the quantity of the resource for immediate orders by updating one or more data records of the online system to reflect the expected optimal allocation of the quantity of the resource;
fulfilling the plurality of orders by allocating the expected optimal allocation of the quantity of the resource maintained in the one or more data records of the online system.

2. The method of claim 1, further comprising:
receiving, by the online system, a potential scheduled order for fulfillment during the timeslot; and
determining, by the online system, whether a portion of the quantity of the resource, besides the reserved expected optimal allocation of the quantity of the resource, is available to fulfill the potential scheduled order.

3. The method of claim 2, further comprising:
determining, by the online system, that there is not the portion of the quantity of the resource available to fulfill the potential scheduled order; and
declining, by the online system, the potential scheduled order.

4. The method of claim 2, further comprising:
determining, by the online system, that there is the portion of the quantity of the resource available to fulfill the potential scheduled order; and
confirming, by the online system, the potential scheduled order.

5. The method of claim 1, wherein the machine learning model is trained on experimentally gathered data comprising a plurality of experimental timeslots and, for each experimental timeslot in the plurality of experimental timeslots, one or more of: a quantity of the resource available during the experimental timeslot, a quantity of immediate orders during the experimental timeslot, a quantity of scheduled orders during the experimental timeslot, an experimental allocation of the quantity of the resource reserved for immediate orders during the experimental timeslot, and a resulting value of the fulfillment metric for the experimental timeslot.

6. The method of claim 1, wherein determining, by the online system, the quantity of the resource available in the timeslot to fulfill orders during the timeslot, comprises:
applying, by the online system, a second machine learning model to the timeslot to produce an estimate of the quantity of the resource available in the timeslot to fulfill orders during the timeslot.

7. The method of claim 1, wherein determining, by the online system, the quantity of the resource available in the timeslot to fulfill orders during the timeslot, comprises:
determining a number of shoppers available to fulfill orders, wherein the fulfillment metric is a conversion rate based on a number of users placing orders before and end of the timeslot divided by a number of users that visit a page of a customer mobile application.

8. A computer program product comprising a non-transitory computer readable storage medium having instructions encoded thereon that, when executed by a processor, cause the processor to:
receive a plurality of orders from devices associated with a plurality of users of an online system, each order comprising a request for the online system to fulfill the order during a timeslot, wherein the plurality of orders comprise one or more immediate orders placed during the timeslot and one or more scheduled orders that are scheduled before the timeslot for fulfillment during the timeslot;
determine a quantity of a resource available in the timeslot to fulfill the plurality of orders during the timeslot;
apply the quantity of the resource to a machine learning model to produce a predicted relationship between a value of a fulfillment metric and an allocation of the quantity of the resource reserved for immediate orders;
determine based on the predicted relationship, an expected optimal allocation of the quantity of the resource that maximizes the fulfillment metric;
reserve, the expected optimal allocation of the quantity of the resource for immediate orders by updating one or more data records of the online system to reflect the expected optimal allocation of the quantity of the resource;
fulfill the plurality of orders by allocating the expected optimal allocation of the quantity of the resource maintained in the one or more data records of the online system.

9. The computer program product of claim 8, wherein the instructions further comprise instructions that cause the processor to:
receive a potential scheduled order for fulfillment during the timeslot; and
determine whether a portion of the quantity of the resource, besides the reserved expected optimal allocation of the quantity of the resource, is available to fulfill the potential scheduled order.

10. The computer program product of claim 9, wherein the instructions further comprise instructions that cause the processor to:
determine that there is not the portion of the quantity of the resource available to fulfill the potential scheduled order; and
decline the potential scheduled order.

11. The computer program product of claim 9, wherein the instructions further comprise instructions that cause the processor to:
determine that there is the portion of the quantity of the resource available to fulfill the potential scheduled order; and
confirm the potential scheduled order.

12. The computer program product of claim 8, wherein the machine learning model is trained on experimentally gathered data comprising a plurality of experimental timeslots and, for each experimental timeslot in the plurality of experimental timeslots, one or more of: a quantity of the resource available during the experimental timeslot, a quantity of immediate orders during the experimental timeslot, a quantity of scheduled orders during the experimental timeslot, an experimental allocation of the quantity of the resource reserved for immediate orders during the experimental timeslot, and a resulting value of the fulfillment metric for the experimental timeslot.

13. The computer program product of claim 8, wherein instructions to determine the quantity of the resource available in the timeslot to fulfill orders during the timeslot, comprise instructions to:
apply a second machine learning model to the timeslot to produce an estimate of the quantity of the resource available in the timeslot to fulfill orders during the timeslot.

14. The computer program product of claim 8, wherein instructions to determine the quantity of the resource available in the timeslot to fulfill orders during the timeslot, comprise instructions to:
determine a number of shoppers available to fulfill orders, wherein the fulfillment metric is a conversion rate based on a number of users placing orders before and end of the timeslot divided by a number of users that visit a page of a customer mobile application.

15. A system, comprising:
a processor; and
a non-transitory computer readable storage medium having instructions encoded thereon that, when executed by the processor, cause the processor to:
receive a plurality of orders from devices associated with a plurality of users of an online system, each order comprising a request for the online system to fulfill the order during a timeslot, wherein the plurality of orders comprise one or more immediate orders placed during the timeslot and one or more scheduled orders that are scheduled before the timeslot for fulfillment during the timeslot;
determine a quantity of a resource available in the timeslot to fulfill the plurality of orders during the timeslot;
apply the quantity of the resource to a machine learning model to produce a predicted relationship between a value of a fulfillment metric and an allocation of the quantity of the resource reserved for immediate orders;
determine based on the predicted relationship, an expected optimal allocation of the quantity of the resource that maximizes the fulfillment metric;
reserve, the expected optimal allocation of the quantity of the resource for immediate orders by updating one or more data records of the online system to reflect the expected optimal allocation of the quantity of the resource;
fulfill the plurality of orders by allocating the expected optimal allocation of the quantity of the resource maintained in the one or more data records of the online system.

16. The system of claim 15, wherein the instructions further comprise instructions that cause the processor to:
receive a potential scheduled order for fulfillment during the timeslot; and
determine whether a portion of the quantity of the resource, besides the reserved expected optimal allocation of the quantity of the resource, is available to fulfill the potential scheduled order.

17. The system of claim 16, wherein the instructions further comprise instructions that cause the processor to:
determine that there is not the portion of the quantity of the resource available to fulfill the potential scheduled order; and
decline the potential scheduled order.

18. The system of claim 16, wherein the instructions further comprise instructions that cause the processor to:
determine that there is the portion of the quantity of the resource available to fulfill the potential scheduled order; and
confirm the potential scheduled order.

19. The system of claim 15, wherein the machine learning model is trained on experimentally gathered data comprising a plurality of experimental timeslots and, for each experimental timeslot in the plurality of experimental timeslots, one or more of: a quantity of the resource available during the experimental timeslot, a quantity of immediate orders during the experimental timeslot, a quantity of scheduled orders during the experimental timeslot, an experimental allocation of the quantity of the resource reserved for immediate orders during the experimental timeslot, and a resulting value of the fulfillment metric for the experimental timeslot.

20. The system of claim 15, wherein instructions to determine the quantity of the resource available in the timeslot to fulfill orders during the timeslot, comprise instructions to:
apply a second machine learning model to the timeslot to produce an estimate of the quantity of the resource available in the timeslot to fulfill orders during the timeslot.
